(19) United States
(12) Patent Application Publication
(10) Pub. No.: US 2022/0072440 A1
(43) Pub. Date: Mar. 10, 2022

(54) INFLATABLE SPRINKLER WITH INTEGRAL CATCH SYSTEM

(71) Applicant: Snow Goose Games LLC, Wilmington, DE (US)

(72) Inventor: Jacob Deutsch, Highland Mills, NY (US)

(73) Assignee: Snow Goose Games LLC, Wilmington, DE (US)

(21) Appl. No.: 17/470,762

(22) Filed: Sep. 9, 2021

Related U.S. Application Data
(60) Provisional application No. 63/076,724, filed on Sep. 10, 2020.

(51) Int. Cl. A63H 23/10; B05B 17/08; A63B 67/06

(52) U.S. Cl. CPC A63H 23/10; B05B 17/08; A63B 2225/62; A63B 2067/063; A63B 67/06

(57) ABSTRACT

Inflatable toys and related methods are generally described. In some embodiments, an inflatable toy may be multifunctional, allowing a user to use the toy for multiple activities. In some embodiments, the toy may be used to play a game, such as ring toss, and may also have an added functionality of fluid sprinkling. In some embodiments, the toy's functionalities may be used in parallel or separately. In some embodiments, the toy may include one or more projections which may receive one or more rings. In some embodiments, the toy may include a nozzle which may be configured to expel pressurized fluid (e.g., water) to cool the surrounding environment.

### CROSS-REFERENCE TO RELATED APPLICATIONS

This application claims the benefit under 35 U.S.C. § 119(e) of U.S. provisional application Ser. No. 63/076,724, filed Sep. 10, 2020, the disclosure of which is incorporated by reference in its entirety.

### FIELD

Disclosed embodiments are related to toys and inflatables, and more particularly, to inflatable water toys.

### BACKGROUND

When visiting the pool or beach, children and adults alike often enjoy playing with beach balls, pool toys, and inflatables. In particular, inflatable sports-type toys, such as tossing, shooting and throwing games, are common and well enjoyed.

### SUMMARY

In some embodiments, a toy includes a flexible shell forming a cavity therein and having at least one inlet valve configured to receive fluid for introduction into the cavity. For example, air and/or water can be introduced into the cavity to inflate the flexible shell. When inflated, the flexible shell can have a shape of an animal, such as a triceratops or other dinosaur, a cow, horse, or other animal. A first port on the shell can be configured to fluidly couple with a fluid source for a first fluid, such as water. For example, the first port can be configured to couple with a water hose to receive water. At least one nozzle on the flexible shell (e.g., positioned distant or remote from the first port, can be fluidly coupled with the first port via an internal tube in the cavity and configured to emit fluid received at the first port. For example, water received at the first port can be carried by an internal tube inside the flexible shell and within the cavity to the at least one nozzle, which can emit the water into an environment around or otherwise external to the flexible shell. In some cases, the nozzle can function as a water sprinkler used for play by children or other people, e.g., on a hot day. At least one projection can extend from the flexible shell, e.g., the projection can be a part of the flexible shell and be inflated by air introduced into the cavity. The projection can form one or more parts of an animal shape defined by the flexible shell, such as a horn, ear, snout, etc. of the animal. The at least one projection can be configured to receive at least one structure, such as a hoop or other ring-shaped element that is thrown by a user onto the projection from a distance, e.g., as a ring toss game. In some cases, the nozzle can emit water or other fluid in a direction along which rings or other throwable structures are tossed onto the at least one projection. Thus, the emitted water can provide an obstacle to the user in throwing the ring or other throwable structure onto the projection and/or simply add to the ring toss experience. The nozzle can be positioned on the shell adjacent to the at least one projection and can emit water in a direction along which the at least one projection extends. In some cases, at least one obstacle portion can be provided on the flexible shell and positioned proximal to the at least one projection. The obstacle portion can be configured to guide a throwable ring or other structure onto the at least one projection, and/or be configured to prevent the throwable ring or other structure from being positioned on the at least one projection.

In some embodiments, a method of operating a toy includes inflating a flexible shell of the toy with a first fluid, such as air. Inflation of the flexible shell can be done by introducing air, water and/or other fluid into a cavity defined by the flexible shell via at least one valve on the flexible shell, and can cause the flexible shell to have a shape that resembles a dinosaur or other animal. A second fluid can be introduced into a first port of the flexible shell that is in fluid communication with a nozzle on the flexible shell. In some cases, the second fluid can be water provided to the first port by a water hose, and the water can be carried by an internal tube that is within the cavity and is fluidly coupled between the first port and the nozzle. The second fluid can be ejected from the nozzle, e.g., into an environment external to the flexible shell. In some cases, at least one throwable structure such as a ring can be positioned around at least one projection extending from the flexible shell, e.g., by tossing a ring onto the projection. In some cases, the second fluid can be ejected by the nozzle from a location on the flexible shell that is adjacent or otherwise near a projection and can be emitted in a direction along a length of the projection and/or toward a user attempting to toss a ring or other structure onto the projection. In some cases, the flexible shell includes at least one obstacle portion positioned proximal to the at least one projection. The obstacle portion can guide the at least one throwable structure onto the at least one projection and/or prevent the at least one structure from being positioned onto the at least one projection.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows, according to some embodiments, a photograph of an inflatable toy;

FIG. 2 shows, according to some embodiments, an exploded view of an inflatable toy;

FIG. 3 shows, according to some embodiments, a photograph of an inflatable toy;

FIG. 4 shows, according to some embodiments, a close-up of an inlet port of an inflatable toy; and

FIG. 5 shows, according to some embodiments, a photograph of an inflatable toy.

### DETAILED DESCRIPTION

Sports-type toys can be used in outdoor environments to enhance outdoor game play. The Inventors have recognized that in some cases, inflatable toys can have a large volumetric footprint, even when deflated. This may limit the number of toys which can be stored for a given household, and may therefore limit the number of games or activities a household can enjoy. Furthermore, in some cases, inflatable toys can be used in outdoor environments in the summertime. The Inventors have recognized that the elevated temperatures and increased levels of activity may result in tiredness and/or dehydration of the participants (e.g., children playing with the inflatable toys).

In view of the above, the Inventors have recognized the benefits associated with an inflatable toy that can also provide the cooling effects of water on a hot day. The inflatable toy may be convertible between various forms of game play, while maintaining safety and reliability. Instances in which different benefits are offered by the systems and methods disclosed herein are also possible.

In some embodiments, an inflatable toy may be used in an outdoor location or any other suitable location. The inflatable toy may be self-balancing, such that it retains its upright position without external support. In some embodiments, the inflatable toy may be deflated to achieve a small volumetric footprint for storage purposes.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

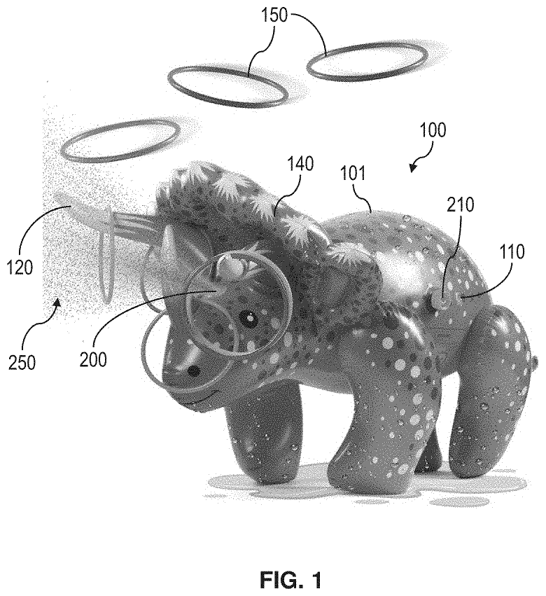

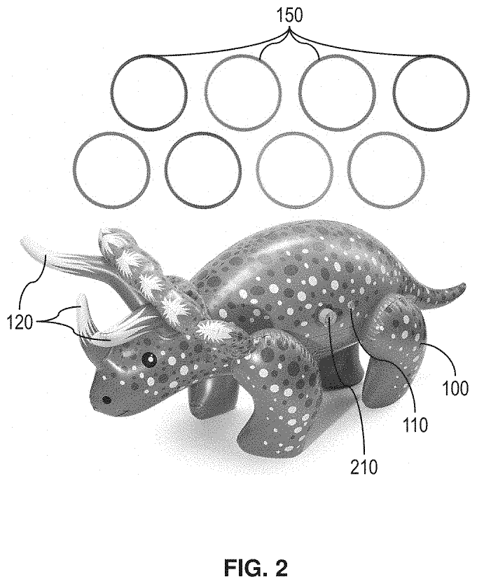

FIGS. 1-2 show an inflatable toy according to some embodiments. As shown, the inflatable toy (hereinafter also referred to as “toy”) 100 may be used for at least two different activities, either in parallel or separately. For example, in some embodiments, the toy may be used for a ring toss activity and a sprinkler. In other embodiments, the toy may be used just for a ring toss. In yet other embodiments, the toy may be used just for a sprinkler. In some embodiments, the toy may be used for at least one activity. In other embodiments, the toy may be used for more than two activities.

In some embodiments, an inflatable toy 100 may include one or more of a shell 101 defining an internal cavity, at least one port 210, at least one valve 110, an internal tube, at least one spray nozzle 200, one or more projections 120, and one or more obstacle portions 140, as shown in FIG. 1. The toy 100 may be associated with, or used with one or more hoops or other ring-shaped elements 150. The shell 101 may be formed of any suitable material to allow the toy 100 to be inflated and/or deflated over several cycles, without considerable wear on the material. The cavity may form the enclosed space within the shell 101, which may be filled with a fluid (e.g., air) to inflate the toy 100. In some embodiments, the port 210 and valve 110 may be positioned on the same side of the shell 101, as shown in FIG. 1. The valve and/or port may be oriented toward the cavity.

In some embodiments, an inflatable toy 100 may include one or more projections 120, suitable for catching one or more structures. In some embodiments, the structures may be hoops and/or rings 150, as shown in FIGS. 1-2. The hoops 150 may be thrown toward the toy 100, such that they may land around the projections 120 for successful game play. The projections 120 may extend from the toy 100 to provide clearance for the hoops 150, but may be angled to maintain structural integrity. In some embodiments, the projections 120 may be positioned in such a manner that reduces the risk of toy collapse due to the added weight. In some embodiments, the toy 100 may include one or more projections 120. The projections 120 may be formed in a visually interesting manner. For example, the projections 120 may be shaped similarly to a horn of a triceratops dinosaur, as shown in FIGS. 1 and 2. It should be appreciated that the position, shape and/or angles of the projections 120 may be specifically formed such that the toy maintains a low center of gravity, reducing the risk of accidental tipping.

The one or more projections 120 and the one or more obstacle portions 140 may be formed of any suitable material (which in some embodiments, may be a flexible material), and may extend from the main body of the toy 100, as shown in FIGS. 1-2. The one or more projections 120 may have any suitable size and may extend any suitable amount (e.g., six inches) away from the main body. The one or more projections may have any suitable aspect ratio to allow a user to place or throw a ring-shaped object around said projection. For example, in some embodiments, the diameter of one or more projections may be less than half the length of the projections. It should be appreciated that the toy may include any suitable number of projections in any suitable arrangement. In some embodiments, the toy may include a plurality of similarly-shaped/sized projections. In some embodiments, the toy may include a plurality of projections with different sizes and/or shapes. The one or more projections 120 may be configured to receive and hold the hoops 150, and prevent said hoops from sliding off the toy 100. In some embodiments, the one or more projections 120, when fully inflated, may have an angle of any suitable amount, such as between 0 and 90 degrees from the placement surface.

In some embodiments, a toy may include one or more obstacle portions 140, which may be positioned at any suitable distance, such as, for example, less than six inches from the one or more projections 120. In some embodiments, one or more obstacle portions 140 may be positioned proximally to the one or more projections 120. The obstacle portions 140 may increase the likelihood (e.g., guide) that the hoops 150 may be received by the at least one or more projections, by providing a backboard against which the hoops may bounce back and on to the at least one of the one or more projections. In some embodiments, the obstacle portions 140 may also decrease the likelihood that the hoops 150 may be received from the at least one or more projections by blocking a descending path of the hoops toward the at least one or more projections.

In some embodiments, the hoops 150 may be inflatable and/or may be formed of a lightweight material (e.g., foam). The hoops 150 may include one or more ports and/or valves configured to inflate the hoops. The hoops may then be deflated to reduce the overall storage footprint of the toy.

It should be appreciated that the inflatable toy may be any suitable shape or structure. In some embodiments, the toy may be shaped like or may resemble an animal, such as a dinosaur, dog, rhinoceros, elephant, lion or any other suitable animal or mythical creature. As shown in FIGS. 1-2, the toy may be shaped like a triceratops. In some embodiments, the spray nozzle 200 may be disposed in any suitable location, such as upon the head. In some embodiments, the one or more projections and/or obstacle portions may be positioned adjacent to the nozzle. The one or more projections and obstacle portions may be disposed in any suitable location.

In some embodiments, the toy 100 may be inflated with air through at least one valve 110. The toy may be inflated through the valve by any suitable means, such as manual inflation by a user or a pump and/or automated inflation using an electrical pump. The toy may include more than one valve to allow for controllable inflation/deflation. In some embodiments, the valve(s) may be embedded into the body of the toy 100. The valve(s) may be secured (e.g., with a cap) to reduce the rate of air (or any other suitable gas) flow into and/or out of the toy. In some embodiments, the toy may include one or more directional valves, which may be suitable to either inflate or deflate the toy. It should be appreciated that any number, arrangement, and/or style of port may be employed to allow the toy to inflate and deflate. In some embodiments, the toy may be permanently inflated, and may not include any physical valves or other ports.

As shown in FIG. 1, in some embodiments, the toy 100 may include at least one nozzle 200. The sprinkler may be in fluid communication and/or fluidly coupled to a fluid source, to allow said fluid to flow out of the toy 100 in a pressurized manner. In some embodiments, the fluid may be water 250. The fluid source may be connected to the toy 100 through a port 210, which may be in fluid communication and/or fluidly coupled to an internal tube (not shown) of the toy. In operation, fluid may flow from the source to the port 210, through the tube, and outward (see water 250 in FIG. 1) from the nozzle 200. It should be appreciated that the inclusion of the tube may maintain the fluid separate from the inflation fluid (e.g., air) of the toy 100.

In some embodiments, the internal tube may include a first opening and a second opening. The first opening may be connected to the port 210, and the second opening may be connected to the nozzle 200. The nozzle 200 (which may be a spray nozzle) may include a nozzle inlet and a nozzle outlet. The nozzle inlet may be configured to receive fluid from the internal tube. The nozzle outlet may be disposed on a side of the spray nozzle, opposite the nozzle inlet. The nozzle outlet may be oriented away from the cavity, and configured to transfer the fluid from the internal tube into an external environment surrounding the inflatable toy. In some embodiments, the spraying of fluid from the nozzle outlet may result in a cooling effect of the external environment.

In some embodiments, a fluid may be introduced into the cavity of the toy to inflate said toy. In some embodiments, the fluid may be a liquid and/or a gas. In some embodiments, the nozzle may expel fluid which may be a liquid and/or a gas. The toy 100 may be configured to be placed upon a placement surface. The placement surface may be any suitable area, such as concrete, or a grassy lawn, and/or any other suitable area.

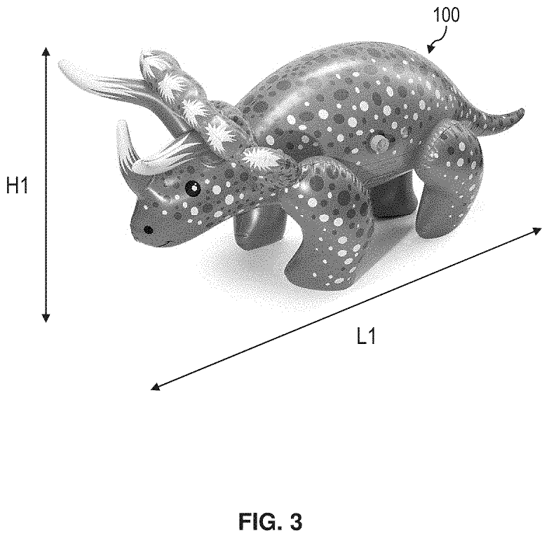

It should be appreciated that the inflatable toy may have any suitable size, as the present disclosure is not so limited. In some embodiments, as shown in FIG. 3, the toy 100 may have an overall height H1 and an overall width W1. In one exemplary embodiment, the overall height H1 of the toy 100 is 22 inches and the overall width W1 is 42 inches. In some embodiments, the measurements (e.g., overall height H1 and overall width W1) may provide stability to maintain upright ability while spraying or otherwise emitting water and/or catching hoops without flipping or tipping over, and while also allowing for the increased weight from the hoops. The overall height H1 may be at least 5 inches, 10 inches, 15 inches, 18 inches, 20 inches, 24 inches, 30 inches, 36 inches, 40 inches, 48 inches, 50 inches, 70 inches, and/or any other suitable value. In some embodiments, the overall height H1 may be greater than or equal to 70 inches, 50 inches, 48 inches, 40 inches, 36 inches, 30 inches, 24 inches, 20 inches, 18 inches, 15 inches, 10 inches, 5 inches, and/or any other suitable value. Combinations of ranges of the foregoing overall height H1 are also contemplated, including between 5 inches and 70 inches, between 20 inches and 50 inches, and/or any other suitable combinations of values. The overall width W1 may be at least 5 inches, 10 inches, 15 inches, 18 inches, 20 inches, 24 inches, 30 inches, 36 inches, 40 inches, 48 inches, 50 inches, 70 inches, and/or any other suitable value. In some embodiments, the overall width W1 may be greater than or equal to 70 inches, 50 inches, 48 inches, 40 inches, 36 inches, 30 inches, 24 inches, 20 inches, 18 inches, 15 inches, 10 inches, 5 inches, and/or any other suitable value. Combinations of ranges of the foregoing overall width W1 are also contemplated, including between 5 inches and 70 inches, between 20 inches and 50 inches, and/or any other suitable combinations of values.

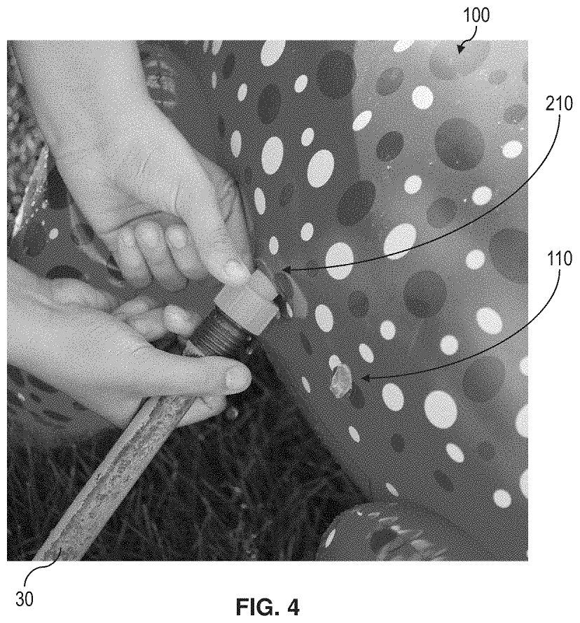

FIG. 4 shows, according to some embodiments, a close-up of a port 210 in fluid communication with a fluid source 30. In some embodiments, the fluid source 30 may be a hose. The hose 30 may be connected and secured to the port 210 in any suitable manner to allow fluid (e.g., water) from the hose to pass through the toy 100 (e.g., through a tube within the toy, not shown) and exit out of one or more nozzles formed on the toy. The hose 30 may remain secured to the toy 100 during game play to allow continuous out flow of water through the nozzle(s).

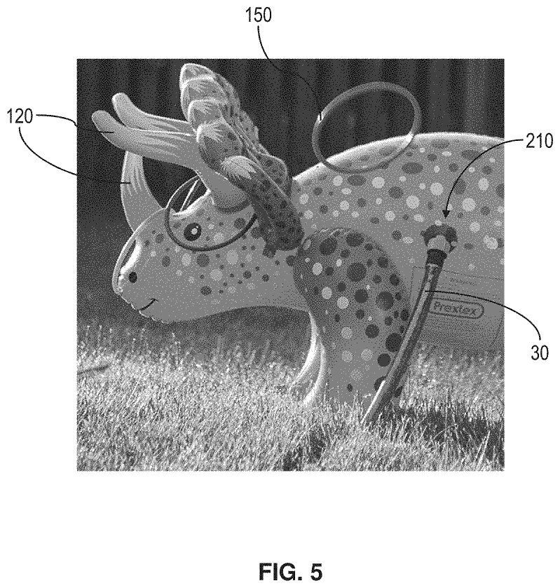

FIG. 5 shows, according to some embodiments, a toy 100 in operation. The toy 100 may include a port 210 which may receive a hose 30, such that it may eject or sprinkle fluid out of a nozzle 200. In some embodiments, as shown, the toy 100 may also receive one or more hoops 150 for additional game play. It should be appreciated that the toy may be used with at least one activity (e.g., ring toss or cooling sprinkle), at least two activities (e.g., ring toss and cooling sprinkle), and/or any other number of activities, simultaneously or separately.

Having thus described several aspects of several embodiments of an inflatable toy, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

The section headings used are for organizational purposes only and are not to be construed as limiting the subject matter described in any way.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A toy comprising:
a flexible shell forming a cavity therein, the flexible shell comprising:
at least one inlet valve configured to receive fluid for introduction into the cavity,
a first port configured to fluidly couple with a fluid source for a first fluid,
at least one nozzle fluidly coupled with the first port via an internal tube in the cavity and configured to emit fluid received at the first port, and
at least one projection extending from the flexible shell,
wherein the flexible shell is configured to be inflated by introducing a fluid into the cavity through the at least one inlet valve, and wherein the at least one projection is configured to receive at least one structure.

2. The toy of claim 1, further comprising at least one obstacle portion on the flexible shell and positioned proximal to the at least one projection.

3. The toy of claim 2, wherein the at least one obstacle portion is configured to guide the at least one structure on to the at least one projection.

4. The toy of claim 2, wherein the at least one obstacle portion is configured to prevent the at least one structure from being positioned on the at least one projection.

5. The toy of claim 1, wherein the at least one structure is ring-shaped and is configured to be thrown onto the at least one projection.

6. The toy of claim 1, wherein the at least one nozzle is configured to sprinkle the fluid received at the at least one port into an environment external to the flexible shell.

7. The toy of claim 1, wherein the flexible shell when inflated has a shape that resembles a dinosaur.

8. The toy of claim 1, wherein the at least one nozzle is configured to spray water from a location on the flexible shell adjacent to the at least one projection and in a direction along a length of the at least one projection.

9. A method of operating a toy, the method comprising:
inflating a flexible shell of the toy with a first fluid;
flowing a second fluid through a first port of the flexible shell, the first port in fluid communication with a nozzle on the flexible shell;
ejecting the second fluid from the nozzle; and
positioning at least one structure around at least one projection extending from the flexible shell.

10. The method of claim 9, wherein inflating the flexible shell further comprises flowing the first fluid through a first valve formed in the flexible shell.

11. The method of claim 9, wherein flowing the second fluid through the first port further comprises flowing the second fluid through an internal tube located in a cavity formed by the flexible shell and extending between the nozzle and the first port.

12. The method of claim 9, wherein the flexible shell comprises at least one obstacle portion positioned proximal to the at least one projection.

13. The method of claim 12, further comprising guiding the at least one structure on to the at least one projection with the at least one obstacle portion.

14. The method of claim 12, further comprising preventing the at least one structure from being positioned on to the at least one projection with the at least one obstacle portion.

15. The method of claim 9, wherein the at least one structure is ring-shaped.

16. The method of claim 9, further comprising sprinkling the second fluid out of the nozzle into an environment external to a flexible shell.

17. The method of claim 9, wherein the flexible shell when inflated has a shape that resembles a dinosaur.

18. The method of claim 9, wherein the first fluid is air and the second fluid is water.
